(19) United States
(12) Patent Application Publication
(10) Pub. No.: US 2026/0241941 A1
(43) Pub. Date: Aug. 20, 2026

(54) Computer-implemented method for monitoring a deep neural network and applications thereof

(71) Applicant: Continental Autonomous Mobility Germany GmbH, Ingolstadt (DE)

(72) Inventors: Gesina Schwalbe, Lübeck (DE); Michelle Karg, Lindau (DE); Antje Elisabeth Loyal, Frankfurt am Main (DE)

(73) Assignee: Continental Autonomous Mobility Germany GmbH, Ingolstadt (DE)

(21) Appl. No.: 19/152,520

(22) PCT Filed: Feb. 8, 2024
(86) PCT No.: PCT/DE2024/035009

§ 371 Date: Jul. 31, 2025

(30) Foreign Application Priority Data
Feb. 14, 2023 (DE) 10 2023 201 196.4

(51) Int. Cl. B60W 50/00; B60W 60/00; G06T 7/70; G06V 10/764; G06V 10/776; G06V 10/82; G06V 20/58

(52) U.S. Cl. CPC B60W 50/0098; B60W 60/001; G06T 7/70; G06V 10/764; G06V 10/776; G06V 10/82; G06V 20/58; B60W 2050/0022; B60W 2050/0028; B60W 2420/403; B60W 2554/402; B60W 2554/4041; G06T 2207/20084; G06T 2207/30261

(57) ABSTRACT

A computer-implemented method for monitoring an artificial deep neural network comprises supplying input data to the trained deep neural network monitored, in order to obtain therefrom output data activation map data, and supplying the input data, the output data and the activation map data to a computer-implemented network observer. The network observer generates masking data from the activation map data and/or the input data and/or the output data; masks the activation map data using the masking data in order to obtain masked activation map data, wherein the masked activation map data contain unmasked activation values and masked activation values; and determines an outlier score for the output data using the masked activation map data, wherein merely the unmasked values are taken into account when determining the outlier score. The outlier score is a numerical value and indicates the extent to which the determined output deviates from a typical case.

### CROSS REFERENCE TO RELATED APPLICATIONS

This application is the U.S. National Phase Application of PCT International Application No. PCT/DE2024/035009, filed Feb. 8, 2024, which claims priority to German Patent Application No. 10 2023 201 196.4, filed Feb. 14, 2023, the contents of such applications being incorporated by reference herein.

### FIELD OF THE INVENTION

The invention relates to a computer-implemented method for monitoring an artificial deep neural network. Furthermore, the invention relates to a computer-implemented perception method, a method for controlling an autonomous vehicle and corresponding apparatuses.

### BACKGROUND OF THE INVENTION

A comparatively large amount of training data is usually required in order to improve the safety of Al-based autonomous systems. Validation data are additionally required for the control and validation of the training and test data for the application.

Labeling this data is a constant challenge due to the time involved. The underrepresentation of rare or uncommon situations represents a further challenge. The behavior of the trained autonomous system can then be unpredictable or undesirable in borderline cases, so-called corner cases or edge cases. The undesirable behavior can arise, for example, as a result of the neural network being uncertain in some places and other neurons being activated accordingly, which show an undesirable output as a result.

### BRIEF SUMMARY OF THE INVENTION

An aspect of the invention aims to improve the reliability of deep neural networks.

An aspect of the invention provides a computer-implemented method for monitoring an artificial deep neural network (DNN), which has a multiplicity of network layers, each having at least one artificial neuron, wherein the method comprises:
a) supplying input data to a deep neural network to be monitored, which is trained for a task, in order to obtain therefrom output data and activation map data, wherein the output data are generated in accordance with the trained task, wherein the activation map data indicate for each neuron what activation value this neuron has;
b) supplying the input data, the output data and the activation map data to a computer-implemented network observer which carries out the following steps of:
aa) generating masking data from the activation map data and/or the input data and/or the output data;
bb) masking the activation map data using the masking data in order to obtain masked activation map data, wherein the masked activation map data contain unmasked activation values and masked activation values;
cc) determining an outlier score for the output data using the masked activation map data, wherein merely the unmasked values are taken into account when determining the outlier score, wherein the outlier score is a numerical value;
dd) assigning the outlier score to the respective output data and, optionally, to the input data for further joint processing.

It is preferred that the masking data are generated by means of a threshold such that those activation values which lie below the threshold are masked in step aa).

It is preferred that the masking data are generated using saliency data such that those activation values which spatially coincide with regions in the input data which were irrelevant for the output data are masked in step aa).

It is preferred that the masking data are generated using the output data such that those activation values which do not match a predetermined reference class, bounding box or combination of both are masked in step aa).

It is preferred that the masking data are inverted following generation or are generated inverted in step aa).

It is preferred that the masking data are generated using the output data by placing a grid of input boxes over the input data and masking those activation values, in which the associated input boxes overlap with a bounding box in the output data at least partially, preferably by more than half according to area, in step aa).

It is preferred that at least one part of the masking data is generated using another criterion or in another way than at least another part of the masking data in step aa).

It is preferred that the steps aa) and bb) are carried out multiple times and indeed in each case for a set of masking data, wherein each set of masking data has been generated using another criterion or in another way than the preceding set or all of the preceding sets of masking data.

It is preferred that the outlier score is determined by determining a neuron coverage for the activation map data and outputting it as the outlier score; or by determining an average neuron coverage during training of the DNN, wherein the neuron coverage determined during operation is compared with the average neuron coverage and the difference is output as the outlier score in step cc).

It is preferred that the outlier score is determined by determining a correlation value for the activation map data and outputting it as the outlier score in step cc).

It is preferred that the outlier score is determined by clustering the activation map data accruing during training of the DNN, wherein a distance from the nearest cluster is determined for the activation map data determined during operation and the distance is output as the outlier score in step cc).

An aspect of the invention provides a computer-implemented perception method, in particular for object recognition, wherein the method comprises:
a) providing image data by means of a storage medium or a sensor;
b) processing the image data by a deep neural network which is trained for object recognition in order to obtain object recognition data which indicate where an object of a particular semantic class is located in the image data;
c) monitoring the deep neural network by a previously described method in order to obtain an outlier score for the result from step b);
d) assigning the outlier score to the object recognition data in order to process the outlier score together with the object recognition data for generating a control signal.

An aspect of the invention provides a computer-implemented method for controlling an autonomous vehicle by a vehicle control unit, wherein the method comprises:
a) carrying out a perception method in order to obtain object recognition data which are indicative of a type and position of an object contained in the image data, wherein the object recognition data additionally contain an outlier score for each object or each relevant image region;
b) generating a control signal for the vehicle control unit, wherein the control signal prompts the vehicle control unit to control the autonomous vehicle in accordance with the control signal.

An aspect of the invention provides a data processing device which has means which are adapted to carry out one, multiple or all of the steps of a previously described method.

An aspect of the invention provides an autonomous vehicle which comprises at least one sensor and a data processing device designed as a vehicle control unit, wherein the vehicle control unit is connected to the sensor in order to process the image data thereof.

An aspect of the invention provides a computer program which has instructions for a data processing device, wherein the instructions prompt the data processing device to carry out one, multiple or all of the steps of a previously described method.

An aspect of the invention provides a machine-readable data carrier medium or data carrier signal which contains the computer program.

Thanks to the use of masking, it is possible to focus on regions which are actually of interest for the case under consideration. Furthermore, the inclusion of activations from the background or by neighboring objects in the calculation of the outlier score can be avoided. Furthermore, the masking allows a massive reduction in the computational and/or storage requirements and can therefore make possible the real-time capability of the ideas described herein.

Furthermore, no outliers are required in the training data set. By considering the intermediate outputs, that is to say the activations, the chances of recognizing processing errors or inconsistencies are improved. Furthermore, the distinction between examples which lie “in-distribution”, but which are nevertheless difficult for the DNN to process (e.g., model-specific decision boundaries), and examples which are “out-of-distribution” from the DNN's point of view can be improved.

One reason for the undesirable behavior of the neural network can be erroneous or incomplete training data. In order to exclude such errors, one approach is to check the neuron activation for the entire data set. It can therefore be recognized whether there are dead neurons or whether certain neurons are activated in an undesirable manner in borderline cases. The objective is to establish the occurrence of these situations in order to subsequently prevent them, if possible.

The so-called neuron coverage indicates the ratio of activated neurons to the total number of neurons in a monitored neural network. In this case, a neuron is deemed to be activated if it exceeds a certain threshold. As a general rule, the selected threshold depends on the available activation interval. If the activation of the neuron can assume values between 0 and 1, for example, 0.5 is usually selected as the threshold.

The neuron coverage can be calculated for an individual image or by summing up the activations per neuron. In this case, in a large part of the literature, the neuron coverage is applied to the entire network, that is to say all of the layers and all of the neurons, to the entire input, that is to say the entire input image, and to all of the inputs, that is to say the entire data set.

However, this approach can be unwieldy because, as a general rule, very large output data are produced which cannot be created or processed or can only be created or processed with great difficulty during the runtime of the monitored neural network or in real time. To that end, a restriction to individual layers of the neural network or to individual image sections is possible.

In one embodiment, the masking data can be configured so that the masking is applied to the outputs of selected layers of the network. In one embodiment, it is possible that the masking data are assigned to certain regions of the input data, for instance certain image regions in the case of image data as the input data.

In one embodiment, the masking data can be generated based on different masking criteria. In other words, the masking data can be generated by combining different masking criteria and applied once.

In one embodiment, the masking data can be generated, separated according to masking criteria. The masking data are then preferably applied consecutively.

In the case of the approach presented here, the neuron coverage is considered as a so-called outlier score which is determined for masked regions of an image or an image section. However, another conventional method can also be used for the outlier score.

One idea is to exclude relevant regions from the input data by means of a mask.

The relevant regions are connected with the final task, for example semantic segmentation, classification or object recognition.

The relevant regions for object recognition are, for example, those which contribute to the final decision, e.g., the paw and the head of a dog for the recognition of a dog, however not the ground or a table next to it.

The masking of the bounding box is preferably based only on activations which lie on the object. However, this only makes sense if the respective neurons can be assigned to a spatial region of the input data. In particular, this is the case if it is one of the network architectures explained below. Thus, it is possible to avoid that activations which are merely located in background regions or regions of neighboring objects are taken into account when calculating the neuron coverage.

One idea used here is the targeted masking of activation maps in neural networks (NNs), such as convolutional neural networks (CNNs for short), transformer networks and recurrent neural networks (RNNs for short), in particular gated recurrent units (GRUs for short). Merely a part of the activation information is forwarded therewith to a network observer for processing by the latter. Neuron coverage methods are preferably used for recognizing abnormalities.

A further idea is to use an automatic masking criterion. One possible way of realizing this is to utilize saliency maps. The saliency map can utilize the spatial assignment of image regions in the input to neural activations. In particular, this can be used in the case of CNNs and similar architectures.

In one embodiment, the saliency map is produced based on perturbations. Random features in the input are removed or changed and the effect on the DNN output is measured. The importance of the input features for the output can be determined using this. Multiple evaluations of the monitored DNN are preferably carried out on changed versions of the input. DNN-internal information can therefore be dispensed with. Examples of this are SHAP (SHapley Additive explanations), disclosed in Lundberg et al. 2017 “A Unified Approach to Interpreting Model Predictions.” Incorporated herein by reference. In Advances in Neural Information Processing Systems 30, 4765-74. http://papers.nips.cc/paper/7062-a-unifiedapproach-to-interpreting-model-predictions.pdf., and LIME (Local Interpretable Model-agnostic Explanations) disclosed in Ribeiro et al. 2016 “‘Why Should I Trust You?’: Explaining the Predictions of Any Classifier.” Incorporated herein by reference. In Proc. 22nd ACM SIGKDD Int. Conf. Knowledge Discovery and Data Mining, 1135-44. KDD ‘16. https://doi.org/10.1145/2939672.2939778., the contents of which are incorporated herein by reference.

In one embodiment, the saliency maps can be generated based on backpropagation. For this, the activations of the output are traced back to the input in accordance with given rules. A special case is gradient backpropagation. This is advantageous because said information accrues anyway, as a general rule, during training of the DNN and can thus be further used. Examples are LRP (Layer-wise Relevance Propagation), disclosed in Bach et al. 2015 “On Pixel-Wise Explanations for Non-Linear Classifier Decisions by Layer-Wise Relevance Propagation.” PLOS ONE 10 (7): e0130140. https://doi.org/10.1371/journal.pone.0130140., incorporated herein by reference, and Sensitivity Analysis, disclosed in Baehrens et al. 2010, “How to Explain Individual Classification Decisions.” Journal of Machine Learning Research 11 (August): 1803-31, the contents of which are incorporated herein by reference.. A further advantage is that no spatial assignment of the activations to input image regions is required for LRP. Furthermore, in the case of backpropagation-based methods—such as LRP—the saliency maps can also be created directly on the activation maps. A calculation step from the input back to the activations can therefore be dispensed with.

In one embodiment, the saliency maps can be generated based on activation maps of convolutional networks For CNNs, the neural activations in the intermediate layers can be assigned to spatial regions in the input image. As a general rule, the resolution capability is limited by possibly lower resolution of the activation maps and the receptive field, disclosed in Luo et al. 2016 “Understanding the Effective Receptive Field in Deep Convolutional Neural Networks.” Incorporated herein by reference. In Advances in Neural Information Processing Systems, 29:4898-4906. Barcelona, Spain: Curran Associates, Inc. https://proceedings.neurips.cc/paper/2016/hash/c8067ad1937f728f51288b3eb986afaa-Abstract.html, of the respective neurons. Incorporated herein by reference. Said assignment can be utilized in order to assign a higher relevance for the output to image regions having a high intermediate activation. Absolutely no additional DNN evaluations are required; for that reason, no class-specific information is obtained, except in combination with backpropagation techniques.

Examples of this are CAM (Class Activation Mapping), disclosed in Zhou et al. 2016, “Learning Deep Features for Discriminative Localization.” In Proc. 2016 IEEE Conf. Comput. Vision and Pattern Recognition, 2921-29. Las Vegas, NV, USA: IEEE Computer Society. https://doi.org/10.1109/CVPR.2016.319., incirporated herein by reference. and hybrids such as Grad-CAM (Gradient Class Activation Mapping), disclosed in Selvaraju et al. 2017 “Grad-CAM: Visual Explanations from Deep Networks via Gradient-Based Localization.” In Proc. 2017 IEEE Int. Conf. Computer Vision, 618-26. Venice: IEEE. https://doi.org/10.1109/ICCV.2017.74, the contents of which are incorporated herein by reference.

In one embodiment, the masking with the aid of saliency maps can comprise selecting one or more outputs. Thereafter, the saliency map is calculated with respect to the outputs based on the activations of the input neurons, that is to say the original image input, or on the activation maps. Once the saliency map has been calculated for the input, the saliency map values are preferably assigned to the corresponding neural activations. It is preferred that the masks are binarized by applying a threshold to the saliency map values.

In general, the method described herein comprises at least the following steps:

A masking criterion is evaluated on the image or the activation maps. In other words, a suitable mask is generated for the neuron activation. The activation maps can be masked, in particular with the objective of focusing on the activation patterns and/or of simplifying the activation patterns. The mask can also lead to a reduction in the size of the activation map.

An outlier criterion is evaluated and an outlier score is determined for each detection or each relevant image region.

The outlier score is further used in the respective application. The outlier score is indicative of a magnitude of the deviation of the monitored neural network from a similar normal case. The outlier score can be used, for example, to increase the uncertainty in a sense-plan-act pipeline and prompt the latter to enlist (dynamic) additional information for the evaluation. Examples of such information are, for instance, temporal or spatial information which is suitable for verifying or rejecting the detection which is associated with a high outlier score. It should be taken into account that additional information which is required for a verification can frequently be “expensive” in the evaluation. It can therefore be advantageous to evaluate the additional information only in the event of a high degree of uncertainty or a high probability of error.

The outlier criterion can be a function which accepts the activation of the neurons unobstructed by the mask from one or more layers as an input and determines therefrom an outlier score, for example as a number. The function can be selected so that a high outlier score indicates that the examined input is an outlier for the monitored NN or deep NN (deep neural network, DNN for short). In other words, the outlier score can indicate that the result of the NN is based on a test input which, rather, belongs to the edge region of the training data distribution.

The test input can be, e.g., a rare case (for instance, people in costumes), an adversarial example (i.e., an outlier with respect to non-semantic features) or a case which is not generally covered by the training data (e.g., a night image if merely daylight training data was available).

The determination of the outlier score can be based on a post-hoc analysis of the activations within the network. The weights of the network are only trained for the application. The outlier score is not determined until the activations are in each case fixed for one example after a feed forward of test data.

Various approaches can be used for determination based on one or more given activation maps.

In one embodiment, a neuron coverage criterion can be used. A proportion of activated neurons, i.e., those which exceed a previously stipulated threshold, can be determined. In this configuration, the monitored NN can in particular be checked for false negatives. This is attributed to the fact that in such a case, higher-than-average activations indicate an overlooked object.

A further possibility is to use a neural correlation criterion. The neuron coverage criterion can be extended such that not only the ratio of activated neurons to total neurons, but rather the activation patterns thereof are assessed. Correlations of various neurons within one or more layers can therefore be considered. It is therefore possible to take account of functions for the outlier score which are merely mapped by the combination of multiple layers or activations.

In one embodiment, statistical values of the activations can be enlisted as the basis of the outlier score.

In a further embodiment, the clustering of the activation patterns can be used. The activation pattern which has been caused by an input can be compared with the nearest known cluster of activation patterns. In particular, the distance between the example and the next known cluster is determined in this abstract space.

These basic possibilities can be modified even further in order to reduce or minimize the size of the activation patterns which simultaneously produce an outlier score. The required computing resources, in particular computing power/time and working memory, can therefore be reduced and, surprisingly, the accuracy of the outlier score can be improved at the same time. This is attributed to the fact that the calculation of the score, in this case, is based on more relevant regions and the influence of background regions or regions of other objects is reduced.

In one embodiment, this is achieved by means of masking on the basis of the previously determined mask. The neurons can be masked by simply setting their activation to 0 for the determination of the outlier score. In other words, masked neurons are considered to not be activated (having a zero value).

In one embodiment, region-of-interest (Rol) pooling can be used. In order to determine the outlier score for a detection or an image region, the activation pattern can be restricted to an area of specified or predicted size around the selected image region. Additional measures can be helpful in order to obtain activation patterns of standardized size. Object size or area size can be restricted by additional pooling (Rol pooling as in older standard detectors, e.g., Faster R-CNN).

Anchors having multiple standard sizes per anchor can be used. A separate outlier criterion can be used for each size category. In other words, the outlier criterion can be evaluated per anchor and per size category. Only one preselected size category can preferably be evaluated for an input and an anchor, e.g., the one that best matches the bounding box size. One embodiment provides that different outlier criteria are applied to various reference classes similarly to the class-wise neuron coverage. Reference classes can be obtained from the objectness, from object classes/super classes or from object subclasses.

The objectiveness indicates a value for a binary classification whether it is an “object” or “no object”. This value is of particular interest for the evaluation of false negatives.

The object classes/superclasses can refer to, e.g., a vehicle, pedestrian, etc.

Object subclasses can be used if corresponding DNN outputs are available (e.g., small car, truck, adult, child). The reference class can already be included as a reference class during masking, for example by merely leaving all of the pedestrians unmasked.

The masking preferably makes use of a function which accepts an input, the activation patterns of a DNN, as well as the DNN output and returns, for example, a binary mask for the activation patterns therefrom. It is also conceivable that the mask has a “fuzzy” design so that certain input data points are at least partially let through by the mask.

The masking makes it possible to simplify the activation patterns for the further processing. On the one hand, the computational burden and storage outlay can therefore be reduced. On the other hand, the subsequent evaluation of the outlier criterion can be restricted to the relevant regions in the activation patterns. Not only is it therefore possible to determine the presence of an outlier, but rather a localization of where the outlier is located in the input is possible therewith.

The masking function can be given or restricted by one or more consecutively applied criteria. The criteria help to determine which activations are relevant. If a reference class has been selected, the criteria can also be specific to the respective reference class.

One possibility is to use a pre-selection by criticality criteria, e.g., plausibility or (in)consistency (strange position, temporal inconsistency such as, e.g., tracking: person disappears/appears, dirt on the recording optics, etc.); uncertainty of the DNN output; and criticality of the image region (e.g., edge regions).

In one embodiment, the masking criteria help to identify false positives, for example saliency maps and DNN outputs.

Saliency maps allow only regions of the activation maps to be used which spatially coincide with regions in the input which were relevant for the output. The DNN outputs can be mapped back into the image. For example, in the case of semantic segmentation or instance segmentation for objects, a reduction to the segmented areas which preferably match the selected reference class and/or the selected object can be effected. The bounding boxes which preferably match the selected reference class can be taken into account. It is also conceivable to combine the approaches with one another.

For the identification of false negatives, it is preferable to invert the masking in relation to false positives. Consequently, the regions which could contain false negatives are used for the calculation of the outlier score. One possible way to do this is to invert the regions which would be marked for false positives (e.g., regions having predicted detections, regions which were important for detections, or similar). As a result, those regions which probably contain no false positives and, accordingly, possibly, false negatives can be selected. A high outlier score in these regions (in particular if the reference class “no object” is selected) can then indicate a false negative.

In one embodiment, a sliding window is used. In the case of the sliding window, a parallel evaluation is conducted for each image region for a grid made of (partially) overlapping image regions of the same size. This is preferably restricted to image regions which do not belong to a detection. It can therefore be answered whether an image region, in which no detection is located, contains an abnormality and therefore possibly a false negative.

For the most part, no uniform image regions are specified, e.g., by detections. In other words, there are normally no bounding boxes for “no detection”. The image regions can therefore be selected explicitly. A sliding window approach is proposed for this, in which a grid of overlapping boxes is preferably placed over the image region of the input. Bounding boxes which belong to a detection or which overlap, in large part, with a detection are preferably completely excluded. An outlier score is determined regarding each of the remaining boxes on the neural activations which spatially belong to the remaining bounding boxes, by means of the same outlier criterion.

In this case, the outlier score can be an indicator of whether the activations which did not lead to a detection at a location are abnormal (and therefore a false negative possibly exists). Abnormal activations can be, e.g., excessively strong activations.

Generally, it can be safely assumed that regions without objects, in general, have low activations.

The measures disclosed here can be used for DNN-based perception applications, e.g., in the case of an advanced driver assistance system, ADAS for short). An application in the field of perception for mobile robots, interior monitoring, intelligent infrastructure, camera-based quality control in production or automated (pre-)labeling is also conceivable.

The quality of detections can be checked with the aid of the outlier score during quality control for DNN-based perception applications. A stable behavior of the activations in the face of disturbances such as noise, adversarial attacks, etc., is desirable for a good detector. If a detector fluctuates greatly in the activations in the event of small changes to the input images, this can indicate a certain susceptibility to interference of the monitored DNN. The outlier score can be used as a measure in order to measure the robustness of said DNN and to react appropriately thereto, for example by rejecting the test result and repeating the quality control. It is also possible to supply the quality-controlled object to a manual check and, if necessary, to utilize the result of the manual check for further training of the monitored DNN.

During (pre-)labeling of training and test data sets, these can be improved by continually extending the samples. In this case, the outlier score can be used in order to identify critical samples which should possibly be subjected to a manual check. Moreover, a verification or quality control of the monitored DNN can be carried out based on the outlier score.

It is likewise possible to carry out operation-time controls, that is to say control during the runtime of the DNN. This is advantageous, for example, when using autonomous mobile systems in a traffic space. In this case, the outlier score can be used in order to identify critical detections during runtime, in the sense of detections which are not sufficiently reliable. Said identified critical detections can subsequently be checked by means of an additional detector or scene information.

### BRIEF DESCRIPTION OF THE DRAWINGS

Exemplary embodiments of the invention are explained in greater detail below with reference to the appended schematic drawings, wherein:

FIG. 1 shows an exemplary embodiment of an autonomous vehicle;

FIG. 2 shows an exemplary embodiment of a monitoring method; and

FIG. 3 shows a representation illustrating the localization of an abnormality.

### DETAILED DESCRIPTION OF THE EMBODIMENTS

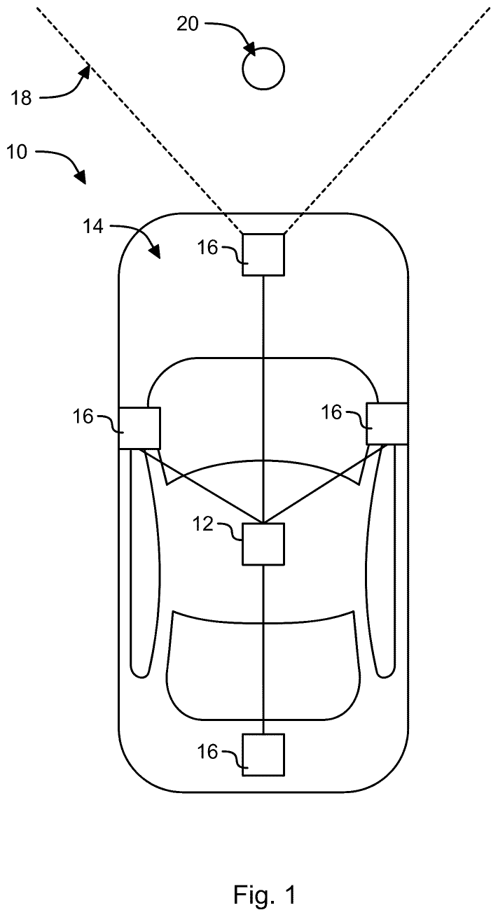

FIG. 1 shows an autonomous vehicle 10. The vehicle 10 is an example of an autonomous system. The vehicle 10 has a vehicle control unit 12 which is adapted to control the vehicle 10, that is to say, for example, to accelerate, decelerate or steer the vehicle 10. The vehicle control unit 12 is an example of a control unit. It is also possible that the vehicle control unit 12 controls a display for the driver. The vehicle control unit 12 is preferably designed as a data processing device.

The vehicle 10 comprises a sensor system 14. The sensor system 14 can be designed to capture the surroundings of the vehicle 10. The sensor system 14 comprises at least one sensor 16, for example an imaging sensor such as, for instance, a camera. So many sensors 16 are preferably arranged on the vehicle that the entire 360° surroundings of the vehicle 10 can be captured. Each sensor 16 has its own sensor range 18 which is captured by the sensor 16.

An object 20 can be located in the sensor range 18. This can be a road sign, for example. Other examples of the object 20 are, for instance, obstacles (guardrail, bollard and the like), traffic lights, pedestrians, cyclists and generally any other class of object which is useful during autonomous driving in the traffic space.

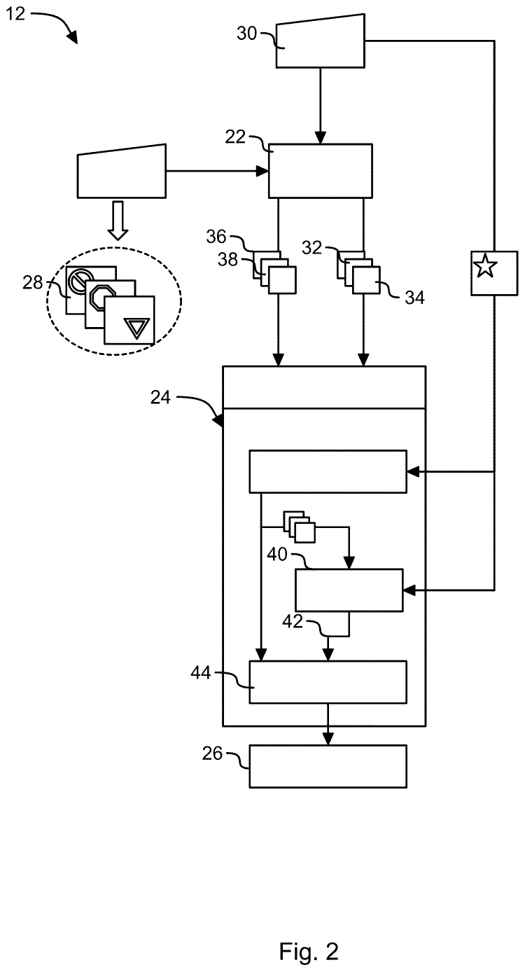

FIG. 2 shows that the vehicle control unit 12 contains a deep neural network 22 (DNN for short) which is trained for object recognition, especially in road traffic. The DNN 22 can, for example, be trained to recognize road signs. The DNN 22 can be a convolutional neural network (CNN). Such networks for object recognition are known and will therefore not be explained in greater detail.

The vehicle control unit 12 furthermore contains a computer-implemented network observer 24 which monitors the DNN 22. The network observer 24 is adapted to determine an outlier score 26 which indicates whether, and if applicable to what extent, output data of the DNN 22 are to be attributed to abnormal behavior. It can preferably be assumed that the output data are based on abnormal behavior of the DNN 22 if the outlier score 26 lies outside a predefined range or exceeds a predefined threshold. The outlier score 26 is preferably a numerical value.

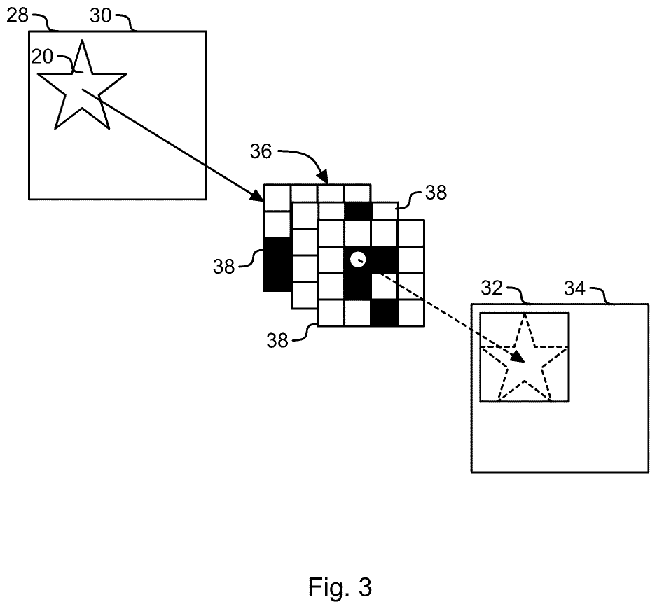

A method for controlling the autonomous vehicle 10 is explained in greater detail using FIG. 2 and FIG. 3. A journey of the autonomous vehicle 10 on a road having road signs serves as an example.

The vehicle control unit 12 prompts the sensor system 14 to capture image data 28 of the surroundings of the autonomous vehicle 10 by means of the sensors 16. The image data 28 contain object data which are indicative of the object 20. In this example, it is assumed that the object 20 is a road sign which indicates a speed limit. Unlike the training examples, the object 20 can, however, have been changed in an unfavorable way, for example due to contamination of the sensors 16 or of the object 20, unfavorable incidence of light and the like.

The image data 28 are supplied to the DNN 22 as input data 30. The DNN 22 carries out an object recognition in the feed-forward in the known way per se and generates object recognition data 32 as output data 34. The object recognition data 32 preferably contain a bounding box for each recognized object, a semantic classification of the recognized object and, optionally, a probability indication which indicates the probability with which the classification of the recognized object coincides with the true class of the object 20.

In the present example, the object recognition data 32 can contain a bounding box. In other words, the DNN 22 was able to determine the presence of the object 20 and the position thereof in the image data 28. Furthermore, the DNN 22 can, as a general rule, also recognize that it is a road sign, in particular due to the external shape. However, it can be that the speed could not be recognized, for example due to contamination of the sensors 16, partial contamination or occlusion of the road sign or an incidence of light which merely highlights the outlines of the object 20 against the background, but makes the imprint “invisible” (for example, a backlight situation with a low sun).

Activation map data 36 are generated during the feed-forward of the input data 30. The activation map data 36 contain an activation map 38, which contains the activation values of the individual neurons of the respective layer of the DNN 22, for each layer of the DNN 22.

The input data 30, the output data 34 and the activation map data 36 are supplied to the network observer 24 and processed there.

The network observer 24 generates therefrom masking data 40. The masking data 40 indicate which activation map data 36 are taken into account in the further course and which are not. For example, the masking data 40 can contain a masking map 42 for each activation map 38. The masking data 40 can, for example, be generated by means of a threshold. The network observer 24 can mask the activation map data 36, for example, by setting all of the data which are no longer to be taken into account according to the masking data 40 to a zero value. However, the zero value can, but does not necessarily have to, correspond to the number zero.

Each masking map 42 can be generated, by way of example, from the associated activation map 38 by setting all of the entries which are equal to or above a predefined threshold value to “1”, while all of the other entries are set to “0”. “1” preferably means that the corresponding entry in the activation map 38 to be masked should be further taken into account while, in the case of “0”, the corresponding entry of the activation map 38 should no longer be taken into account.

In this variant, the network observer 24 generates masked activation map data 44 from the masking data 40 and the activation map data 36, the dimensions of which remain unchanged. The masked activation map data 44 then typically form a sparsely populated matrix.

In one variant, depending on the selected masking criterion, the masked activation map data 44 can be stored and processed more efficiently as a smaller matrix together with a location indication. This is because if, for example, a sliding window is used in an intermediate step in order to generate masks, the non-zeroized values of the masked activation map data 44 are the same size for all positions of the sliding window. The masked activation map data 44 can therefore be represented as activations merely of the size of the sliding window, together with an indicator of the location at which the sliding window was located in the input data 30, for example image data.

The network observer 24 can determine the outlier score 26 using the masked activation map data 44. The network observer 24 can determine the outlier score 26 using the so-called neuron coverage. The neuron coverage corresponds to the ratio of activated neurons to the total number of all of the neurons.

That is to say that the network observer 24 preferably determines the current neuron coverage for the object 20 which has just been processed. The current neuron coverage can be output as an outlier score 26. It is also possible that the network observer 24 compares this result with the average neuron coverage of the DNN 22 which is determined during the training. The difference between the current neuron coverage and the average neuron coverage can alternatively be output as the outlier score 26. This variant is in particular suitable for false negatives because these are usually accompanied by an above-average current neuron coverage.

In the case of the road sign, the current neuron coverage is significantly increased because not only are the activations which are associated with a specific road sign above the threshold, but rather all of the activations which are associated with a road sign having at least a similar external shape.

Thereupon, the network observer 24 assigns the outlier score 26 to the output data 34 and transmits these to the vehicle control unit 12.

The vehicle control unit 12 processes the output data 34 and the outlier score 26. If the vehicle control unit 12 establishes that the outlier score 26 lies above a predefined threshold, the output data 34 can be deemed to be relatively unreliable. As a reaction thereto, the vehicle control unit 12 can, for example, prompt the repetition of the image capture and subsequent evaluation by the DNN 22. The vehicle control unit 12 can also activate other sensors of the sensor system 14 in order to obtain supplementary input data which augment the previous input data 30 in order to analyze said data together.

The vehicle control unit 12 can prompt a database query. The vehicle control unit 12 can prompt the output of a warning to the driver that a road sign could not be recognized so that the driver can take corrective action.

In the case of the example of the road sign, the vehicle control unit 12 can, for example, determine the position of the autonomous vehicle 10 by means of a satellite navigation system and subsequently determine the speed limit using corresponding stored road map data. The vehicle control unit 12 can then prompt the autonomous vehicle 10 to accelerate or decelerate.

In one variant, the network observer 24 reduces the input data 30, the output data 34 and/or the activation map data 36 before they are used to generate the masking data 40. For example, the resolution can be reduced. A MaxPool function can be used for this.

Further embodiments of the invention are described below only inasmuch as they differ from the embodiment described so far.

Further variants of determining the outlier score 26 are explained below. It should be noted that the different ways of determining the outlier score 26 (including the previously described embodiment) can be combined with any of the different ways of determining the masking data 40 described below.

In a further embodiment, the network observer 24 can determine the outlier score 26 on the basis of the neural correlation. The number of activated neurons is not simply counted, but rather the activation patterns contained in the activation map data 36 are assessed. In particular, at least one correlation value can be determined within the activation maps 38 and/or from activation maps 38 for the different layers of the DNN 22. The more the correlation value(s) for the input data 30 deviate from the average correlation values for regular test data, the more probable it is that it is an outlier. Accordingly, the resulting outlier score 26 is higher.

In a further embodiment, the network observer 24 can determine the outlier score 26 by means of clustering. To that end, the activation patterns are first plotted in the activation maps 38 during the training of the DNN 22 and are clustered by means of a known clustering method such as the k-means algorithm. The distance from the nearest cluster is determined and output as an outlier score 26 for the activation maps 38 generated by the input data 30 during the feed forward, more precisely, the activation patterns contained therein. If, as a consequence, the activation patterns deviate significantly from the trained situations, the outlier score 26 is higher and the output data 34 is therefore marked as less reliable.

Further variants of the determination and application of the masking data 40 are explained below. It should be noted that these embodiments are compatible with and can therefore be used with any type of determination of the outlier score 26.

In a further embodiment, the network observer 24 can generate the masking data 40 on the basis of saliency data. The saliency data indicate which regions of the activation map data 36 spatially coincide with those regions of the input data 30 which were relevant for the output data 34. In other words, each masking map 42 can be based on a saliency map which is determined for each layer of the DNN 22. The methods with which saliency maps can be determined are known per se and are not explained in greater detail here. Reference is made in particular to the following publications:
Lundberg et al. 2017 “A Unified Approach to Interpreting Model Predictions.” In Advances in Neural Information Processing Systems 30, 4765-74.
Ribeiro et al. 2016 “‘Why Should I Trust You?’: Explaining the Predictions of Any Classifier.” In Proc. 22nd ACM SIGKDD Int. Conf. Knowledge Discovery and Data Mining, 1135-44. KDD ‘16.
Bach et al. 2015 “On Pixel-Wise Explanations for Non-Linear Classifier Decisions by Layer-Wise Relevance Propagation.” PLOS ONE 10 (7): e0130140.
Baehrens et al. 2010, “How to Explain Individual Classification Decisions.” Journal of Machine Learning Research 11 (August): 1803-31.
Luo et al. 2016 “Understanding the Effective Receptive Field in Deep Convolutional Neural Networks.” In Advances in Neural Information Processing Systems, 29:4898-4906. Barcelona, Spain: Curran Associates, Inc.
Zhou et al. 2016, “Learning Deep Features for Discriminative Localization.” In Proc. 2016 IEEE Conf. Comput. Vision and Pattern Recognition, 2921-29. Las Vegas, NV, USA: IEEE Computer Society.
Selvaraju et al. 2017 “Grad-CAM: Visual Explanations from Deep Networks via Gradient-Based Localization.” In Proc. 2017 IEEE Int. Conf. Computer Vision, 618-26. Venice: IEEE. https://doi.org/10.1109/ICCV.2017.74.

In one embodiment, the network observer 24 can use those output data 34 which can be mapped back into the input data 30 to generate the masking data 40. In the case of the semantic segmentation or instance segmentation for objects, this includes the reduction to those segmented areas which belong to a selected reference class or match the selected object. For example, those regions of the output data 34 which correspond to the reference class “road sign” in the input data 30 can be used to generate the masking data 40 for the object 20. It is also conceivable to use the bounding boxes contained in the object recognition data 32 in order to generate the masking data 40. Both approaches can also be combined.

In a further embodiment, the uncertainties determined by the semantic segmentation can serve as masking data 40. Regions having uncertainty values which exceed or fall below a specified threshold can be examined for atypical activations.

The embodiments explained above are in particular suitable for identifying false positive outliers. If false negative outliers are recognized, the network observer 24 can invert the masking data 40 or create them inverted. In other words, the entries “1” are replaced with “0” and vice versa. The resulting outlier score 26 during this masking is then an indicator of a false negative.

In a further embodiment, which is particularly suitable for false negatives, the network observer 24 can place a grid of overlapping input boxes over the input data 30. Those input boxes which belong to a bounding box or have a region overlap with such a bounding box which is more than half can be excluded using the output data 34, in particular the object recognition data 32 such as, for instance, the bounding boxes. Thereupon, the network observer 24 determines the masking data 40 based on the non-excluded input boxes.

In contrast to other methods, it is not only possible to determine whether the output data 34 constitute an outlier with the measures presented here; rather, it is additionally possible, due to the masking, to determine where the cause of the high outlier score 26 is located in the output data 34. In other words, the network observer 24 is not only able to recognize that an outlier is present, but rather can also determine the position of the outlier/abnormality in the output data 34 and therefore also in the input data 30.

### REFERENCE NUMERALS

10 Autonomous vehicle
12 Vehicle control unit
14 Sensor system
16 Sensor
18 Sensor range
20 Object
22 Deep neural network (DNN)
24 Network observer
26 Outlier score
28 Image data
30 Input data
32 Object recognition data
34 Output data
36 Activation map data
38 Activation map
40 Masking data
42 Masking map
44 Masked activation map data

1. A computer-implemented method for monitoring an artificial deep neural network, which has a multiplicity of network layers, each having at least one artificial neuron, wherein the method comprises:
a) supplying input data to a deep neural network to be monitored, which is trained for a task, in order to obtain therefrom output data and activation map data, wherein the output data are generated in accordance with the trained task, wherein the activation map data indicate for each neuron what activation value this neuron has;
b) supplying the input data, the output data and the activation map data to a computer-implemented network observer which carries out the following steps of:
aa) generating masking data from the activation map data and/or the input data and/or the output data;
bb) masking the activation map data using the masking data in order to obtain masked activation map data, wherein the masked activation map data contain unmasked activation values and masked activation values;
cc) determining an outlier score for the output data using the masked activation map data, wherein merely the unmasked values are taken into account when determining the outlier score, wherein the outlier score is a numerical value;
dd) assigning the outlier score to the respective output data and, optionally, to the input data for further joint processing.

2. The method according to claim 1, wherein the masking data are generated by a threshold such that those activation values which lie below the threshold are masked in step aa).

3. The method according claim 1, wherein the masking data are generated using saliency data such that those activation values which spatially coincide with regions in the input data which were irrelevant for the output data are masked in step aa).

4. The method according to claim 1, wherein the masking data are generated using the output data such that those activation values which do not match a predetermined reference class, bounding box or combination of both are masked in step aa).

5. The method according to claim 1, wherein the masking data are inverted following generation or are generated inverted in step aa).

6. The method according to claim 1, wherein the masking data are generated using the output data by placing a grid of input boxes over the input data and masking those activation values, in which the associated input boxes overlap with a bounding box in the output data at least partially, preferably by more than half according to area, in step aa).

7. The method according to claim 1, wherein the outlier score is determined by determining a neuron coverage for the activation map data and outputting it as the outlier score; or by determining an average neuron coverage during training of the DNN, wherein the neuron coverage determined during operation is compared with the average neuron coverage and the difference is output as the outlier score in step cc).

8. The method according to claim 1, wherein the outlier score is determined by determining a correlation value for the activation map data and outputting it as the outlier score in step cc).

9. The method according to claim 1, wherein the outlier score is determined by clustering the activation map data accruing during training of the DNN, wherein a distance from the nearest cluster is determined for the activation map data determined during operation and the distance is output as the outlier score in step cc).

10. A computer-implemented perception method, for object recognition, wherein the method comprises:
a) providing image data by storage medium or a sensor;
b) processing the image data by a deep neural network which is trained for object recognition in order to obtain object recognition data which indicate where an object of a particular semantic class is located in the image data;
c) monitoring the deep neural network by a method according to claim 1 in order to obtain an outlier score for the result from step b);
d) assigning the outlier score to the object recognition data in order to process the outlier score together with the object recognition data for generating a control signal.

11. A computer-implemented method for controlling an autonomous system by a control unit-(12), wherein the method comprises:
a) carrying out a method according to claim 10 in order to obtain object recognition data which are indicative of a type and position of an object contained in the image data, wherein the object recognition data additionally contain an outlier score for each object or each relevant image region;
b) generating a control signal for the vehicle control unit, wherein the control signal prompts the control unit to control the autonomous vehicle in accordance with the control signal.

12. A data processing device adapted to carry out one, multiple or all of the steps of a method according to claim 1.

13. An autonomous system which comprises at least one sensor and a data processing device designed as a control unit according to claim 12, wherein the control unit is connected to the sensor in order to process the image data thereof.

14. A non-transitory computer program which has instructions for a data processing device, wherein the instructions prompt the data processing device to carry out one, multiple or all of the steps of a method according to claim 1.

15. A non-transitory machine-readable data carrier medium which contains the computer program according to claim 14.
